(19) United States
(12) Patent Application Publication
(10) Pub. No.: US 2006/0219560 A1
(43) Pub. Date: Oct. 5, 2006

(54) Method of manufacturing master disks for magnetic transferring, system of controlling content concentrations in electroforming bath, and magnetic recording medium

(75) Inventor: Seiji Kasahara, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/391,234

(22) Filed: Mar. 29, 2006

(30) Foreign Application Priority Data
Mar. 29, 2005 (JP) 2005-094277

(51) Int. Cl. C25D 7/00; G11B 3/70

(52) U.S. Cl. 205/50; 205/68

(57) ABSTRACT

A method of manufacturing master disks for magnetic transferring, by which a metal disk of a prescribed thickness is formed by electroforming over an original disk on which a convexo-concave pattern matching transfer information is formed, a master substrate is fabricated from the metal disk peeled off the original disk, and a magnetic layer is formed over the convexo-concave pattern of the master substrate, the method comprising the steps of: monitoring either continuously or at prescribed intervals of time the content concentrations in an electroforming bath used for the electroforming, and carrying out bath adjustment to maintain the content concentrations in the electroforming bath within a prescribed range.

### BACKGROUND OF THE INVENTION

1. Field of the Invention

The present invention relates to a method of manufacturing master disks for magnetic transferring, a system of controlling content concentrations in an electroforming bath and a magnetic recording medium, and more particularly to a method of manufacturing master disks for magnetic transferring, which can be suitably applied to transferring of magnetic information, such as format information to a magnetic recording medium for use in hard disk devices and the like, a system of controlling the content concentrations of electroforming bath and a magnetic recording medium for use by this method.

2. Description of the Related Art

Magnetic disks (hard disks), which are magnetic recording media for hard disk drives in rapidly increasing use today, usually undergo writing-in of format information and address information as items of pre-format information before they are built into disk drives after delivery from a magnetic disk manufacturer to a disk drive manufacturer. Though this writing-in can be accomplished with a magnetic head, it is more efficient and preferable to write format information and address information collectively from a master disk on which they are written.

This collective magnetic transferring can be accomplished from a master disk for magnetic transferring (hereinafter sometimes referred to as simply master disk) to a transfer destination disk (hereinafter sometimes referred to as magnetic recording medium or slave disk) in a state in which the two disks are in tight contact with each other. By disposing a magnetic field generating device, such as an electromagnetic device or a permanent magnet device, on one or both of the faces of the slave disk and applying a magnetic field to be transferred thereto, the information held by the master disk (such as servo signals) is magnetically transferred to the slave disk. For accurate magnetic transferring, it is imperative to keep the master disk and the slave disk in tight contact with each other uniformly with no gap between them.

Now, the kind of master disk normally used for this magnetic transferring has a convexo-concave pattern matching information signals on the surface of a master substrate and the surface of this convexo-concave pattern is coated with a magnetic layer. This master disk for magnetic transferring is usually fabricated by coating the face of the convexo-concave pattern with a magnetic layer after going through an electroforming step of transferring a convexo-concave pattern onto the face of a metal disk consisting of an electroformed layer by applying electroforming onto a original disk on which information is formed in a convexo-concave pattern and stacking the metal disk over the original disk, a peeling step of peeling the metal disk off the original disk and a die-cutting step of die-cutting the peeled metal disk in a prescribed size into a master substrate (see Japanese Patent Application Laid-Open No. 2001-256644 for instance).

### SUMMARY OF THE INVENTION

At the step of stacking the metal disk onto which an inverted convexo-concave pattern has been transferred by applying electroforming onto the original disk on which information is formed in a convexo-concave pattern, the fine convexo-concave pattern on the original disk should be transferred accurately. Especially where the minimum bit length is 100 nm or less, namely an original disk involving a convexo-concave pattern whose minimum dimension in the track direction (circumferential direction) is 100 nm or less, electroforming requires even finer accuracy.

Whereas control is so effected at this electroforming step of stacking the metal disk to accomplish satisfactory electroforming by optimizing the distance between electrodes, appropriately regulating the maximum current density or otherwise, the most fundamental requirement is to keep the content concentrations of the electroforming bath to be predetermined value (hereinafter part of the electroforming bath liquid will be referred to as electroforming liquid) throughout the duration of electroforming. While the content concentrations of the electroforming bath inevitably vary with the progress of electroforming, the variation of the content concentrations invites a major change in the electroforming conditions, which not only makes accurate electroforming impossible but also invites variations in the physical properties of the electroformed product including stress, distortion and rigidity.

For this reason, the conventional practice is to control the electroforming bath by regulating its specific gravity and pH during the electroforming of the metal disk. However, rough control of the concentrations in terms of specific gravity does not allow perception of various impacts working during the electroforming process such as, in the case of nickel bath, subtle variations in the nickel content in the electroforming bath arising from the evaporation of moisture, inputting of water, dissolution of nickel and taking-out of the liquid.

Consequently, in order to accurately transfer a fine convexo-concave pattern of 100 nm or less in minimum bit length and to properly control the physical properties of the metal disk formed by electroforming (including stress, distortion and rigidity), regulating the specific gravity and pH of the electroforming bath is insufficient, but the concentrations of different contents of the electroforming bath have to be regulated finely.

An object of the present invention, attempted in view of these circumstances, is to provide a method of manufacturing master disks for magnetic transferring, by which a master substrate having an inverted convexo-concave pattern is fabricated by electroforming an original disk having a convexo-concave pattern matching information signals to stack a metal disk, the method permitting steady formation of a highly accurate metal disk from an original disk having a fine convexo-concave pattern, a system of controlling electroforming bath content concentrations for use by this method, and magnetic recording medium to which satisfactory pre-format information is magnetically transferred.

In order to achieve the object stated above, by a method of manufacturing master disks for magnetic transferring according to a first aspect of the invention, a metal disk of a prescribed thickness is formed by electroforming over an original disk on which a convexo-concave pattern matching transfer information is formed, a master substrate is fabricated from the metal disk peeled off the original disk, and a magnetic layer is formed over the convexo-concave pattern of the master substrate, the method comprising the steps of: monitoring either continuously or at prescribed intervals of time the content concentrations in an electroforming bath used for the electroforming, and carrying out bath adjustment to maintain the content concentrations in the electroforming bath within a prescribed range.

According to the first aspect of the invention, since the content concentrations in the electroforming bath are monitored either continuously or at prescribed intervals of time and bath adjustment is performed to maintain the content concentrations in the electroforming bath within the prescribed range, the content concentrations in the electroforming bath little vary during the electroforming step, making it possible to accurately fabricate a metal disk having desired physical properties.

According to a second aspect of the invention, in the process according to the first aspect, at least one of the content concentrations of Nickel, sulfamic acid, boric acid, sulfuric acid, carbonic acid, ammonia, sodium, organic matters and chlorine in the electroforming bath is monitored.

According to the second aspect of the invention, since bath adjustment is accomplished by monitoring at least one of the content concentrations, including the nick concentration in a nickel sulfamate bath, control can be focused on the concentration of a specific content in the electroforming bath.

According to the first or second aspect of the invention, it is preferable for the content concentrations in the electroforming bath to be quantitatively analyzed by a capillary electrophoretic analysis method. The use of the capillary electrophoretic analysis method makes possible accurate quantitative analysis of the content concentrations in the electroforming bath in a short period of time.

According to a fourth aspect of the invention, there is provided a system of controlling electroforming bath content concentrations, comprising: an electroforming tank, an adjusting tank for supplying an electroforming liquid to the electroforming tank and collecting electroforming liquid overflowing the electroforming tank, a concentration adjuster feeding device for feeding the adjusting tank with concentration adjusters for adjusting content concentrations in the electroforming liquid, a capillary electrophoretic device for measuring content concentrations in the electroforming liquid in the adjusting tank, and a controller, wherein the electroforming liquid in the adjusting tank is automatically sampled at prescribed intervals of time, the content concentrations in the sampled electroforming liquid are quantitatively analyzed with the capillary electrophoretic device, the controller automatically determines the doses of the concentration adjusters to be fed on the basis of the analytical results, bath adjustment is performed by automatically feeding the adjusting tank with the concentration adjusters in the determined dose from the concentration adjuster feeding device, and control is thereby achieved to maintain the content concentrations in the electroforming liquid within a prescribed range.

According to the fourth aspect of the invention, since the electroforming liquid is automatically sampled for quantitative analysis and bath adjustment is accomplished by automatically feeding the concentration adjuster, automatic control is made possible to keep the content concentrations in the electroforming liquid within the prescribed range.

According to a fifth aspect of the invention, there is provided a method of manufacturing master disks for magnetic transferring, by which a metal disk of a prescribed thickness is formed by electroforming over an original disk on which a convexo-concave pattern matching transfer information is formed, a master substrate is fabricated from the metal disk peeled off the original disk, and a magnetic layer is formed over the convexo-concave pattern of the master substrate, an electroforming bath for use in the electroforming being subjected to bath adjustment by using the system of controlling electroforming bath content concentrations according to the fourth aspect of the invention.

According to the fifth aspect of the invention, since the content concentrations in the electroforming bath used for use in the electroforming are automatically controlled, the content concentrations in the electroforming bath little vary during the electroforming step, making it possible to accurately fabricate a master substrate having desired physical properties.

According to a sixth aspect of the invention, there is provided a magnetic recording medium using a master disk for magnetic transferring of any of the first through third and fifth aspects, whereto pre-format information is magnetically transferred.

According to the sixth aspect of the invention, since information is magnetically transferred with precision by using a master disk for magnetic transferring on which a fine convexo-concave pattern matching transfer information is accurately formed and which has desired physical properties, the magnetic recording medium can obtain satisfied pre-format information signals.

As described above, a method of manufacturing master disks for magnetic transferring according to the invention can provide a satisfactory master substrate because the content concentrations of the electroforming bath in forming a metal disk by electroforming are so controlled as to remain with a prescribed range. Also, a system of controlling electroforming bath content concentrations according to the invention permits ready control of the content concentrations of the electroforming bath.

Further, a magnetic recording medium on which pre-format information is magnetically recorded by using a master disk magnetic transferring, fabricated by the method of manufacturing master disks for magnetic transferring according to the invention can provide satisfactory pre-format information signals.

### BRIEF DESCRIPTION OF THE DRAWINGS

FIG. 1 shows a partial perspective view of a master disk;

FIG. 2 shows a sectional view along line A-A in FIG. 1;

FIG. 3 shows a plan of a master substrate;

FIGS. 4A to 4E constitute a process diagram showing a method of manufacturing master disks;

FIG. 5 shows a sectional view of an electroforming device;

FIG. 6 is a configurational diagram illustrating a system of controlling content concentrations in an electroforming bath;

FIG. 7 illustrates the principle of a capillary electrophoretic device;

FIG. 8 is a graph showing an example of output data from the capillary electrophoretic device;

FIG. 9 shows a perspective view of the essential part of a magnetic transfer device; and

FIGS. 10A to 10C constitute a process diagram showing the fundamental steps of a magnetic transferring method.

### DETAILED DESCRIPTION OF THE PREFERRED EMBODIMENTS

A method of manufacturing master disks for magnetic transferring and a magnetic recording medium, which are preferred embodiments of the present invention will be described in detail with referenced to the accompanying drawings.

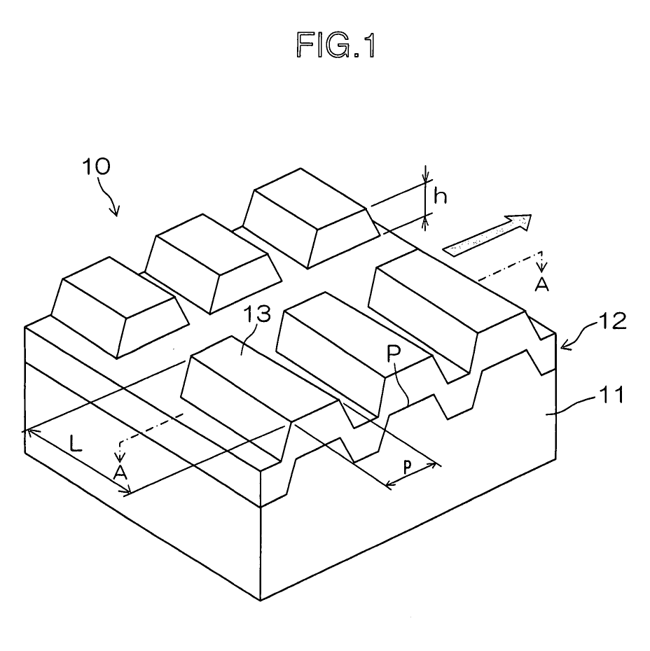

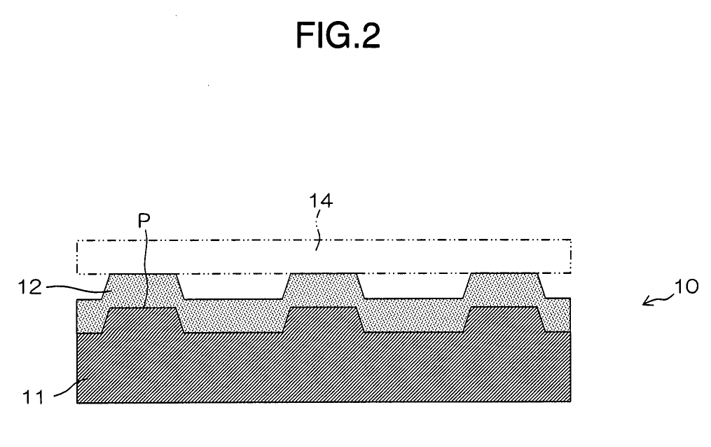

FIG. 1 shows a partial perspective view of a master disk 10 for magnetic transferring (hereinafter to be sometimes referred to simply as master disk 10) and FIG. 2, a sectional view along line A-A in FIG. 1, in which a transfer destination disk (slave disk 14), which is a magnetic recording medium, is depicted in imaginary lines.

As shown in FIG. 1 and FIG. 2, the master disk 10 comprises a metal master substrate 11 and a magnetic layer 12, and a fine convexo-concave pattern P (e.g. a servo information pattern) matching transfer information is formed on the surface of the master substrate 11, the convexo-concave pattern P being coated with the magnetic layer 12.

This causes an information carrying face 13 having the fine convexo-concave pattern P coated with the magnetic layer 12 to be formed over one face of the master substrate 11. As is seen from FIG. 1, this fine convexo-concave pattern P is rectangular in a planar view, and measures p in the length in the tracking direction (the direction of the two-headed arrow in the drawing) and L in the length in the radial direction in a state over which the magnetic layer 12 is formed.

These lengths p and L, whose optimal values differ with the recording density and the recording signal waveform, may be respectively 80 nm and 200 nm for instance. This fine convexo-concave pattern P, where it is a servo signal pattern, is formed longer in the radial direction. In this case, if the length L in the radial direction is 0.05 to 20 μm, it is preferable for the length p in the tracking direction (the circumferential direction) to be 0.01 to 5 μm.

It is preferable to select the convexo-concave pattern P which is longer in the radial direction within this range as a pattern to carry servo signals. The preferable range of the depth h (the height of convexes) for the convexo-concave pattern P is 30 to 800 nm, more preferably a range of 50 to 300 nm.

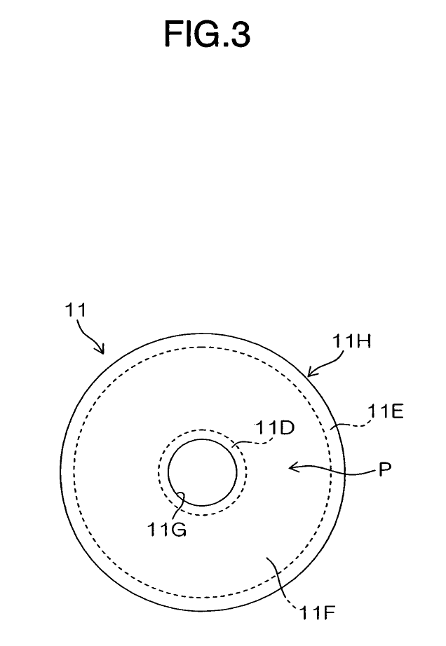

The master substrate 11 is fabricated by electroforming. As shown in FIG. 3, it is formed in a disk shape having a center hole 11G and a circular outer circumference 11H. The convexo-concave pattern P is formed in a circular area 11F on one face (the information carrying face 13) except an inner circumferential part 11D and an outer circumferential part 11E.

Whereas details of the fabrication of this master substrate 11 will be described afterwards, it mainly comprises an electroforming step of electroforming a original disk over which information is formed of the convexo-concave pattern P to produce a metal disk made up of an electroforming layer over the original disk and transferring the convexo-concave pattern P onto the metal disk, a peeling step of peeling the metal disk off the original disk and a die-cutting step of die-cutting the peeled metal disk in a prescribed shape.

According to the invention, though the electroforming layer can be formed of one of various metals or alloys, in this embodiment it is an Ni electroforming layer as a preferable example, which will be supposed in the following description. This Ni electroforming layer is electroformed, with the distance between electrodes being set in a prescribed range at the time of electroforming, while controlling the current density during the electroforming.

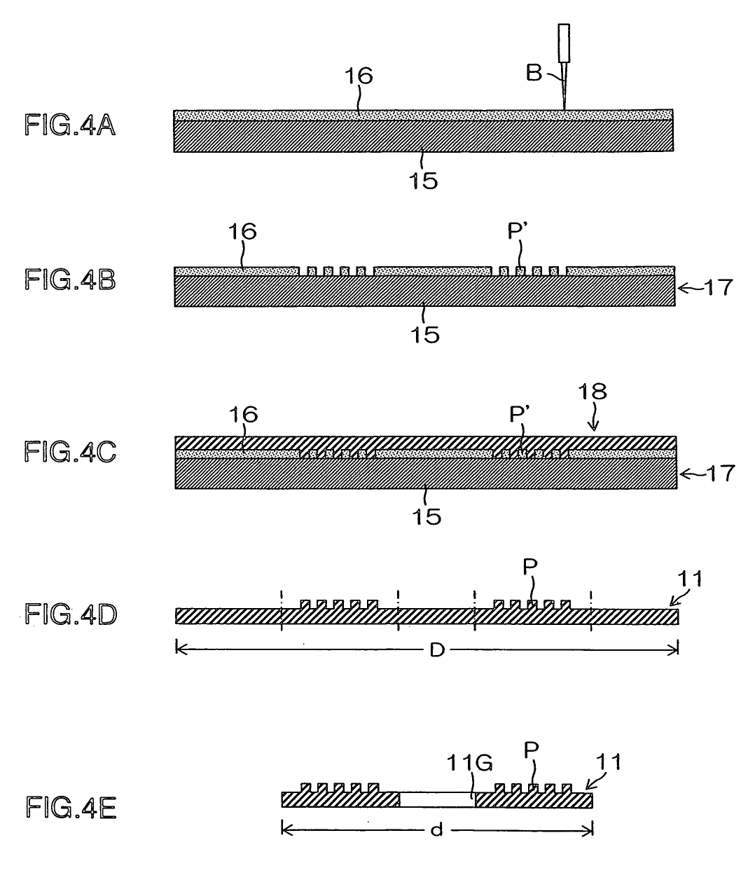

Next, the method of manufacturing the master disk 10 configured as described above will be described in detail. FIG. 4 constitutes a process diagram showing a method of manufacturing the master disk 10. First, as shown in FIG. 4A, pretreatments, including the formation of a tight contact layer, are applied onto a original plate 15 (which may be a glass or quartz plate) of a silicone wafer whose surface is flat, smooth and clean, and an electron ray resist liquid is applied by spin coating or otherwise to form a resist film 16, followed by baking.

Then, the original plate 15 mounted on a highly accurate rotary stage or an X-stage, which is provided on an electron beam exposure device (not shown), is irradiated with an electron beam B modulated to match servo signals or the like, a desired convexo-concave pattern P′ is drawn over the resist film 16 by exposure.

Next, as shown in FIG. 4B, the resist film 16 is developed and deprived of the exposed portion, and the desired convexo-concave pattern P′ is formed of the remaining part of the resist film 16. According to the invention, the convexo-concave pattern P′ is a fine pattern whose minimum pattern size is 100 nm or even less. An Ni electroconductive film (not shown) is provide over this convexo-concave pattern P′ by sputtering, for instance, to fabricate a original disk 17 which permits electroforming.

Then, as shown in FIG. 4C, the whole surface of the original disk 17 is electroformed with an electroforming device to stack a metal disk 18 of Ni (Ni electroformed layer) of a desired thickness. Ni which has a crystalline structure of face-centered cubic lattice, is so electroformed as to manifest a prescribed crystalline structure by controlling the current density during the electroforming.

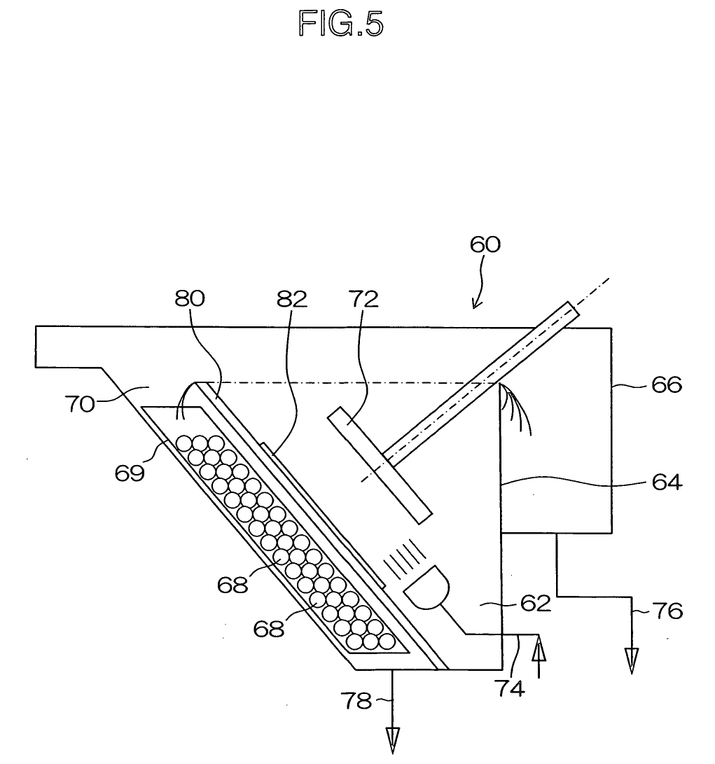

FIG. 5 shows a sectional view of the tank structure of an electroforming device. This electroforming device 60 mainly comprises an electroforming tank 64 for storing an electroforming liquid (bath) 62, a drain tank 66 for receiving part of the electroforming liquid 62 overflowing the electroforming tank 64, an anode chamber 70 which, accommodating a titanium case 69 charged with Ni pellets 68, 68 . . . to serve as anodes, receives the electroforming liquid 62 overflowing the electroforming tank 64, and a cathode 72 holding the original disk 17.

The electroforming liquid 62 is fed to the electroforming tank 64 by way of electroforming liquid feed piping 74. The electroforming liquid 62 overflowing the electroforming tank 64 into the drain tank 66 is collected by way of drain tank discharge piping 76. The electroforming liquid 62 overflowing the electroforming tank 64 into the anode chamber 70 is collected by way of anode chamber discharge piping 78.

The electroforming tank 64 and the anode chamber 70 are separated from each other by a resin partitioning board 80. A current shield board (buffer board) 82 for controlling the flow of the electric current is so fixed to the surface of the partitioning board 80 toward the electroforming tank 64 as to oppose the cathode 72. This current shield board 82 is so formed as to cover prescribed parts of electrodes to uniformize the thickness of the electroformed film within the face.

In the electroforming device 60 configured as described above, the metal disk 18 is electroformed by having the cathode 72 hold the original disk 17, connecting a negative electrode to the cathode 72, connecting a positive electrode to the titanium case 69 of the anode chamber 70, and supplying electricity while revolving the original disk 17 at a speed of 50 to 150 rpm.

Usually, the metal used as the material of the master disk 10 is nickel (Ni). When the master disk 10 is fabricated by electroforming, it is preferable to use a nickel sulfamate bath which would more readily provide a master substrate 11 of lower stress.

A nickel sulfamate bath is obtained by adding as required such an additive as a surface-active agent (e.g. sodium lauryl sulfate) to a base of, for instance, 400 to 800 g/L of nickel sulfamate and 20 to 50 g/L of boric acid (supersaturated). The suitable temperature range of metal plating bath is 40 to 60° C. Preferable opposite electrodes for use in electroforming are the Ni pellets 68, 68 . . . contained in the titanium case 69.

According to the invention, at this electroforming step, content concentrations of the electroforming liquid 62 are monitored, electroforming is performed while so adjusting the bath as to keep the content concentrations within their prescribed ranges. The system of controlling electroforming bath content concentrations to be described can be suitably applied to this bath adjustment.

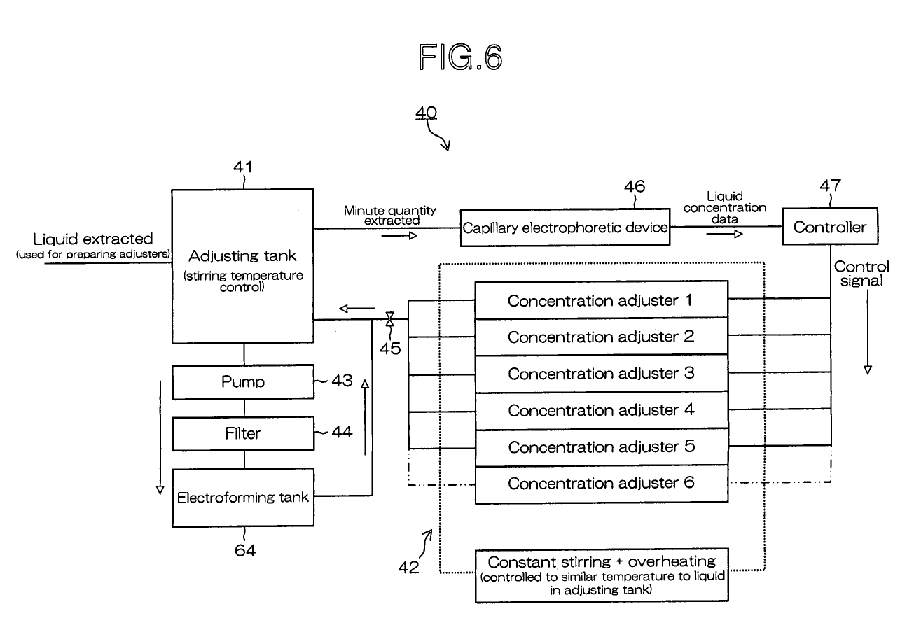

FIG. 6 is a configurational diagram illustrating this system of controlling content concentrations in an electroforming bath. A electroforming bath content concentration controlling system 40 mainly comprises the electroforming tank 64 of the electroforming device 60, an adjusting tank 41 for supplying the electroforming tank 64 with the electroforming liquid 62 and collecting and storing the electroforming liquid 62 overflowing the electroforming tank 64, a concentration adjuster feeding device 42 for inputting to the adjusting tank 41 concentration adjusters for adjusting the content concentrations of the electroforming liquid 62 in the adjusting tank 41, a capillary electrophoretic device 46 for measuring the content concentrations of the electroforming liquid 62 in the adjusting tank 41, and a controller 47 for calculating the doses of concentration adjusters to be inputted from the concentration adjuster feeding device 42 to the adjusting tank 41.

The electroforming liquid 62 in the adjusting tank 41 is supplied by a pump 43 to the electroforming tank 64 via a filter 44. The electroforming liquid 62 overflowing the electroforming tank 64 is also collected by a pump not shown into the adjusting tank 41 via filter, neither shown, and stored therein. The adjusting tank 41 is equipped with a stirring device and a temperature control device for the electroforming liquid 62, which enable the electroforming liquid 62 in the adjusting tank 41 to be uniformized in concentration and kept at a prescribed temperature.

Concentration adjusters 1, 2, 3, . . . are stored in the concentration adjuster feeding device 42 independent of one another. For instance, the concentration adjuster 1 may be rich in nickel; the concentration adjuster 2, highly rich in pure water; the concentration adjuster 3, rich in sulfamic acid; the concentration adjuster 4, rich in boric acid; and the concentration adjuster 5, rich in surface-active agent.

Each of the concentration adjusters is stirred and controlled in temperature to the same level as the electroforming liquid 62 in the adjusting tank 41. The container for storing each concentration adjuster is provided with an electromagnetic valve, independent of a switching valve 45 for the whole concentration adjuster feeding device 42 to enable prescribes doses of concentration adjusters to be inputted to the adjusting tank 41 as instructed by the controller 47.

The electroforming liquid 62 in the adjusting tank 41 is automatically extracted in minute quantities at prescribed intervals of time (e.g. at 30-minute intervals), and its content concentrations are quantitatively analyzed by the capillary electrophoretic device 46. The resultant concentration data on the liquid are delivered to the controller 47, which analyzes the delivered concentration data with a CPU and computes the doses of the concentration adjusters which would enable the content concentrations of the electroforming liquid 62 to be maintained in the prescribed ranges.

The controller 47 issues to the concentration adjuster feeding device 42 an input instruction on the basis of the computed dose of each concentration adjuster. In response to the instruction, the concentration adjuster feeding device 42 inputs to the adjusting tank 41 only as much of each concentration adjuster as the instructed dose. This enables the electroforming liquid 62 in the adjusting tank 41 to remain in the prescribed content concentration ranges all the time, and the electroforming liquid 62 maintained in these prescribed content concentration ranges is fed to the electroforming tank 64 of the electroforming device 60.

Since a nickel sulfamate bath is used for electroforming Ni according to the invention, more specifically the concentrations of nickel, sulfamic acid, boric acid, sulfuric acid, carbonic acid, ammonia, sodium, organic matters, chlorine and so forth in the electroforming liquid 62 are monitored, and liquid adjustment is performed to keep their concentrations within their respective prescribed ranges.

For instance, to adjust the nickel concentration, basic nickel carbonate or a dissolution promoter for the nickel pellets 68 (sulfamic acid) is inputted to raise the nickel concentration, or a liquid of a low nickel concentration is inputted to reduce the nickel concentration.

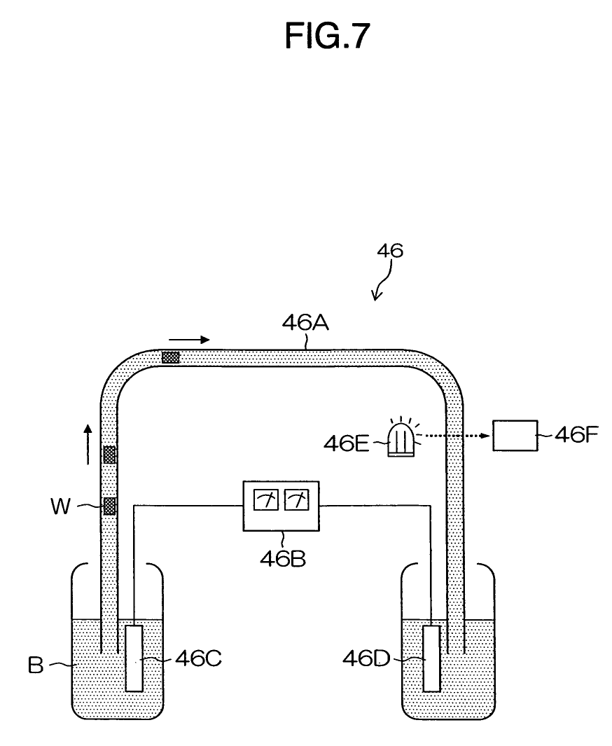

Next, the capillary electrophoretic device 46 for quantitatively analyzing the content concentrations of the electroforming liquid 62 will be described. FIG. 7 illustrates the principle of the capillary electrophoretic device 46.

The capillary electrophoretic device 46 mainly comprises a silica-made hollow capillary (100 μm or less in bore and about 80 cm in length) 46A, a high voltage power source 46B, electrodes 46C and 46D, a light source 46E, a photo-detector 46F and a data processor not shown. The light source 46E emits either visible light or ultraviolet light, and a photodiode or a photomultiplier is used as the photo-detector 46F.

In quantitatively analyzing a sample W, first the capillary 46A is filled with a buffer (buffer solution) B as electrophoretic liquid and, after injecting a minute quantity of the sample W into the capillary 46A, a voltage (−30 KV to +30 KV) is applied to the two ends of the capillary 46A to have an electrophoretic analysis performed.

The moving speed is different in many cases for each component the sample W, varying with the electric charge, size, shape and other factors, and this variety makes possible separation of diverse sample components. In practice, detection is accomplished by measuring with the photo-detector 46F, midway on the capillary 46A, the absorbance of the sample W which comes along.

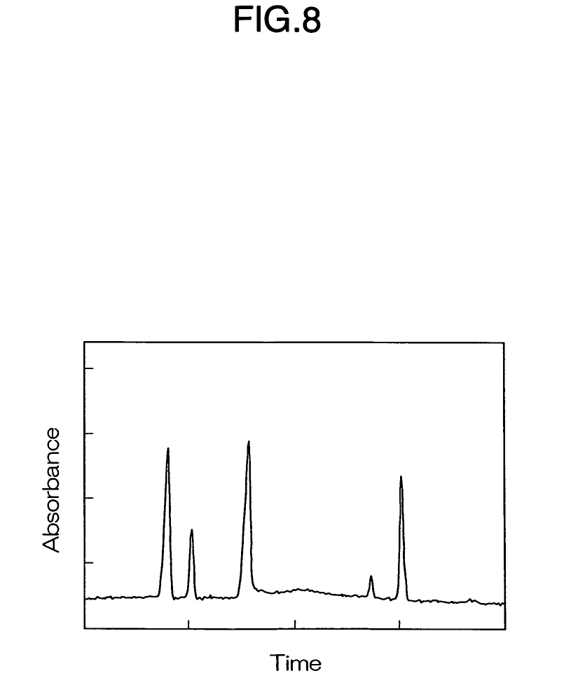

FIG. 8 showing an example of measured absorbance data detected in this way. In the graph, the horizontal axis represents the length of time taken until the start of electric field application until the detection, and the vertical axis, the absorbance. The qualitative and quantitative assaying of each component is possible according to the length of time taken until the start of electric field application until the detection, peak height, square measure and absorption spectrum. Products available for the capillary electrophoretic device 46 include, for instance, a product denominated CAPI-3300 by Otsuka Electronics Co., Ltd.

In this embodiment of the invention, the ratio of the separated nickel quantity required for production of one metal disk 18 to the volume of the electroforming bath 62 at the step of electroforming the metal disk 18 is prescribed as follows. The nickel separation ratio per unit length of time required for production of one metal disk 18 to the volume of the electroforming bath 62 is such that nickel is electroformed at a separation ratio of not more than 1 g/L-H, where g is the weight of nickel separated per unit length of time required for production of one metal disk 18 and L, the volume of the electroforming bath 62.

This prescription is applicable to an electroforming tank 62 of 75 L in capacity, a three-tank type electroforming tank 62 of 270 L in capacity, or even to a large electroforming tank 62 of 1000 L in capacity. The greater the total capacity, the smaller the variations of content concentrations of the electroforming bath 62, contributing to the stability of the physical properties of the master substrate 11 that is fabricated. The lower the separation speed of nickel, the greater the stress reduction and the shape stability, again contributing to the stability of the physical properties of the master substrate 11 that is fabricated.

Referring back to FIG. 4, the metal disk 18 is peeled off the original disk 17, and the remaining resist film 16 is removed, followed by washing. This makes it possible to obtain the original plate 11′ of the master substrate 11 having the inverted convexo-concave pattern P and the outer diameter D before die-cutting into the prescribed size as shown in FIG. 4D.

As this original plate 11′ consists of the metal disk 18 electroformed at the electroforming step with the content concentrations of the electroforming bath 62 controlled as described above and the separation ratio of nickel to the volume of the electroforming bath 62 prescribed, it is a satisfactory electroformed product with its physical properties including stress, distortion and rigidity well controlled and the convexo-concave pattern P′ of the original disk 17 being accurately reproduced.

The master substrate 11 with the prescribed external diameter d as shown in FIG. 4E by die-cutting this original plate 11′. In the die-cutting process, first a protective sheet is stuck to the surface of original plate 11′ on which the convexo-concave pattern P is formed to protect this patterned surface. Products usable as this protective sheet include Silitect available from Trylaner International and KL Sheet from Nitto Denko.

Next, the protective sheet stuck on the convexo-concave pattern P side is peeled off, followed by the formation of the magnetic layer 12 over the convexo-concave pattern P. The magnetic layer 12 can be obtained by forming a film of a magnetic material by one of such vacuum film formation methods including vapor deposition, sputtering and ion plating or, alternatively, plating or painting.

Available magnetic materials for the magnetic layer include Co, Co alloys (CoNi, CoNiZr, CoNbTaZr, etc.), Fe, Fe alloys (FeCo, FeCoNi, FeNiMo, FeAlSi, FeAl, FeTaN, etc.), Ni and Ni alloys (NiFe, etc.). FeCo and FeCoNi are particularly preferable for this purpose. The preferable thickness range of the magnetic layer 12 is 50 to 500 nm, more preferably 100 to 400 nm.

To add, it is preferable to provide over the magnetic layer 12 a protective film of diamond-like carbon (DLC), sputter carbon or the like, and a lubricant layer may be further provided over the protective film. In this case, a preferable configuration may be a combination of a DLC protective film of 3 to 30 nm in thickness and a lubricant layer.

It is also conceivable to dispose a tightly adhering reinforcing layer of Si or the like between the magnetic layer and the protective film. The lubricant would have an effect of reducing detriments to durability, such as the occurrence of scratches by friction which might arise when correcting lags occurring in the process of contact with the slave disk 14. The master disk 10 for magnetic transferring according to the invention is fabricated through these steps.

Another process applicable to the fabrication of the master disk 10 involves electroforming of the original disk 17 to provide a second original disk. This second original disk may be electroformed to provide a metal disk having an inverted convexo-concave pattern P and die-cut to a prescribed size to give the master substrate 11.

Further, a third original disk may be fabricated either by electroforming or the second original disk or hardening it by pressing a resin liquid against the second original disk. This third original disk could be electroformed to provide a metal disk 18, the metal disk 18 having an inverted convexo-concave pattern P is peeled off and die-cut into a prescribed size to obtain the master substrate 11. It is also possible to use the second original disk or the third original disk in repetition to fabricate a plurality of metal disks 18.

In fabricating a original disk, after exposing to light and developing a resist film, the original disk may be etched to form a convexo-concave pattern P′ on its surface, and then the resist film could be removed.

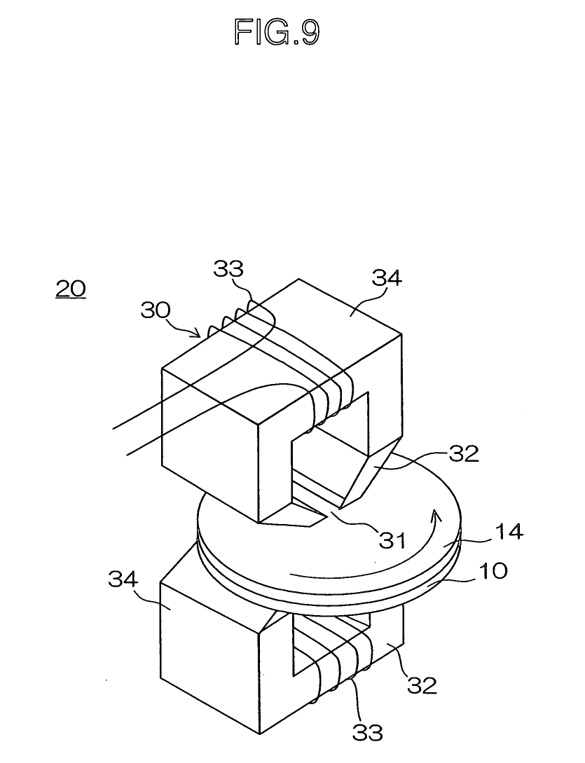

Next, the magnetic transferring method by which the convexo-concave pattern P on the master disk 10 fabricated as described above is transferred to a slave disk 14 will be described. FIG. 9 shows a perspective view of the essential part of a magnetic transfer device 20 for performing magnetic transfers by using the master disk 10 according to the invention.

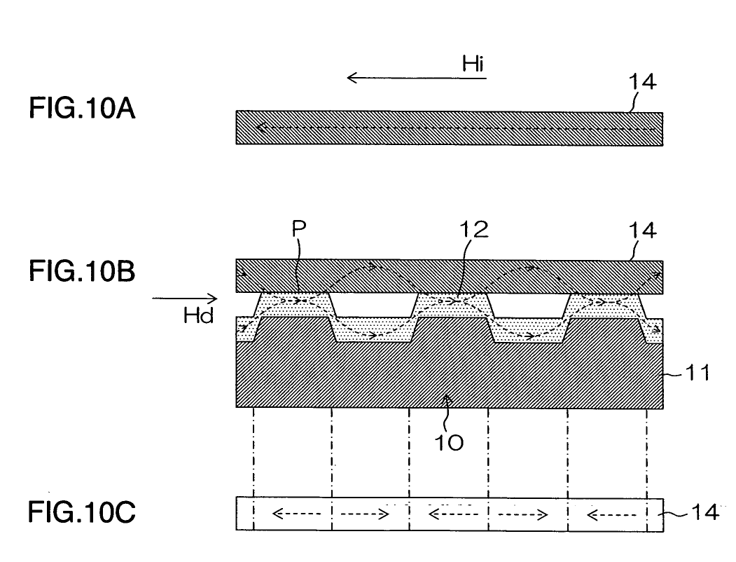

During a magnetic transfer, the slave face (magnetic recording face) of the slave disk 14 having gone through initial D.C. magnetization to be described afterwards, shown in FIG. 10A, is brought into contact with, and tightly stuck with a prescribed pressing force to, the information carrying face 13 of the master disk 10. In this state in which the slave disk 14 and the master disk 10 are tightly stuck to each other, a magnetic field for transferring is applied with a magnetic field generating device 30 to transfer the convexo-concave pattern P on the master disk 10 to the slave disk 14.

The slave disk 14 is a disk-shaped recording medium such as a hard disk, flexible disk or the like over either both faces or one face a magnetic recording layer is formed. Before it is tightly stuck to the master disk 10, the slave disk 14 is subjected as required to cleaning treatment (varnishing or the like) with a glide head, a grinder or the to be cleared of minute projections on and dust stuck to the surface.

The magnetic recording layer of the slave disk 14 may be a painted magnetic recording layer, a plated magnetic recording layer or a metal film type magnetic recording layer. Available magnetic materials for the metal film type magnetic recording layer include Co, Co alloys (CoPtCr, CoCr, CoPtCrTa, CoPtCrNbTa, CoCrB, CoNi, etc.), Fe, Fe alloys (FeCo, FePt, FeCoNi, etc.), Ni and Ni alloys (NiFe, etc.).

These materials are preferable because their high magnetic flux density and magnetic field anisotropy in the same direction as the direction of magnetic field application (intra-facial if recording is intra-facial) enable clear transferring to be accomplished. It is preferable to dispose a non-magnetic under-layer to provide necessary magnetic field anisotropy under the magnetic material (toward the support). It is necessary to match the crystalline structure and lattice constant of this under-layer with those of the magnetic layer 12. For this purpose, it is preferable to use Cr, CrTi, CoCr, CrTa, CrMo, NiAl, Ru or the like.

Magnetic transferring from the master disk 10 may cover only one face of the slave disk 14 by tightly sticking the master disk 10 to that face or, though not shown, both faces of the slave disk 14 to which a pair of master disks 10 are tightly stuck to achieve simultaneous transferring to the two faces.

The magnetic field generating device 30 for applying magnetic fields for transferring has electromagnet devices 34 and 34, each consisting of a core 32 having a gap 31 extending in the radial direction of the slave disk 14 and the master disk 10 which are held tightly stuck to each other, with a coil 33 wound around the core 32, arranged above and underneath. They apply magnetic fields for transferring, having magnetic lines of flux parallel the tracking direction, the same direction both above and underneath.

When applying magnetic fields, the magnetic fields for transferring are applied by the magnetic field generating device 30 while integrally rotating the slave disk 14 and the master disk 10, and the convexo-concave pattern P of the master disk 10 is transferred to the slave face of the slave disk 14. Instead of using this configuration, the magnetic field generating device can be moved rotationally.

In a magnetic field for transferring, there is at least one part where a magnetic field intensity surpassing the upper limit of the optimal transferred magnetic field intensity range (0.6 to 1.3 times the magnetic coercive force Hc of the slave disk 14) exists in neither tracking directions and where the magnetic field intensity is within the optimal transferred magnetic field intensity range. A magnetic field whose intensity in the reverse tracking direction has a magnetic field intensity distribution below the lower limit of the optimal transferred magnetic field intensity range in any position in that tracking direction is generated in one part in the tracking direction.

FIGS. 10A to 10C constitute a process diagram showing the fundamental steps of a magnetic transferring method using intra-facial recording. First, as shown in FIG. 10A, an initial magnetic field Hi is applied to the slave disk 14 in one of the tracking directions to apply initial magnetization (D.C. demagnetization).

Then, as shown in FIG. 10B, the recording face (magnetic recording part) of this slave disk 14 and the information carrying face 13 of the master disk 10 where the convexo-concave pattern P is formed are brought into tight adhesion to each other, and a magnetic transfer is performed by applying a transfer magnetic field Hd in a tracking direction of the slave disk 14 in the direction reverse to the initial magnetic field Hi. The magnetization of this part is not inverted as the transfer magnetic field Hd is inhaled into the magnetic layer 12 in the convex parts of the convexo-concave pattern P, and magnetic fields elsewhere are inverted, with the result that the convexo-concave pattern P of the master disk 10 is magnetically transferred and recorded onto the recording face of the slave disk 14 as shown in FIG. 10C.

In such a magnetic transfer, it is essential for highly accurate transferring that the master disk 10 has an accurate convexo-concave pattern P and that the slave disk 14 and the master disk 10 are tightly stuck to each other in a satisfactory way. By using a master disk 10 fabricated by the method of manufacturing master disks for magnetic transferring according to the invention, on which a minute convexo-concave pattern P is faithfully reproduced and its physical properties including stress, distortion and rigidity are well controlled, satisfactory tight sticking can be achieved, making it possible to obtain a magnetic recording medium 14 of high quality.

As hitherto described, since the method of manufacturing master disks for magnetic transferring according to the present invention uses the system of controlling electroforming bath content concentrations 40 and electroforming is performed with the content concentrations of the electroforming bath 62 being controlled with their respective prescribed ranges, it is made possible, in fabricating the master substrate 11 by stacking the metal disk 18 over the original disk 17 by electroforming, the fine convexo-concave pattern P of the original disk 17 can be accurately transferred and the physical properties of the master substrate 11 can be well controlled, resulting in successful fabrication of a satisfactory master substrate 11. Moreover, by using the master disk 10 fabricated in this way, a high quality magnetic recording medium can be obtained at low cost.

1. A method of manufacturing master disks for magnetic transferring, by which a metal disk of a prescribed thickness is formed by electroforming over an original disk on which a convexo-concave pattern matching transfer information is formed, a master substrate is fabricated from the metal disk peeled off the original disk, and a magnetic layer is formed over the convexo-concave pattern of the master substrate,
the method comprising the steps of:
monitoring either continuously or at prescribed intervals of time the content concentrations in an electroforming bath used for the electroforming, and
carrying out bath adjustment to maintain the content concentrations in the electroforming bath within a prescribed range.

2. The method of manufacturing master disks for magnetic transferring according to claim 1, wherein at least one of the concentrations of Nickel, sulfamic acid, boric acid, sulfuric acid, carbonic acid, ammonia, sodium, organic matters and chlorine in the electroforming bath is monitored.

3. The method of manufacturing master disks for magnetic transferring according to claim 1, wherein the content concentrations in the electroforming bath are quantitatively analyzed by a capillary electrophoretic analysis method.

4. The method of manufacturing master disks for magnetic transferring according to claim 2, wherein the content concentrations in the electroforming bath are quantitatively analyzed by a capillary electrophoretic analysis method.

5. A system of controlling electroforming bath content concentrations, comprising:
an electroforming tank,
an adjusting tank for supplying an electroforming liquid to the electroforming tank and collecting electroforming liquid overflowing the electroforming tank,
a concentration adjuster feeding device for feeding the adjusting tank with concentration adjusters for adjusting content concentrations in the electroforming liquid,
a capillary electrophoretic device for measuring content concentrations in the electroforming liquid in the adjusting tank, and
a controller,
wherein the electroforming liquid in the adjusting tank is automatically sampled at prescribed intervals of time, the content concentrations in the sampled electroforming liquid are quantitatively analyzed with the capillary electrophoretic device, the controller automatically determines the doses of the concentration adjusters to be fed on the basis of the analytical results, bath adjustment is performed by automatically feeding the adjusting tank with the concentration adjusters in the determined doses from the concentration adjuster feeding device, and control is thereby achieved to maintain the content concentrations in the electroforming liquid within a prescribed range.

6. A method of manufacturing master disks for magnetic transferring, by which a metal disk of a prescribed thickness is formed by electroforming over an original disk on which a convexo-concave pattern matching transfer information is formed, a master substrate is fabricated from the metal disk peeled off the original disk, and a magnetic layer is formed over the convexo-concave pattern of the master substrate,
an electroforming bath for use in the electroforming being subjected to bath adjustment by using the system of controlling electroforming bath content concentrations according to claim 5.

7. A magnetic recording medium using a master disk for magnetic transferring of according to claims 1, whereto pre-format information is magnetically transferred.

8. A magnetic recording medium using a master disk for magnetic transferring according to claim 2, whereto pre-format information is magnetically transferred.

9. A magnetic recording medium using a master disk for magnetic transferring according to claim 3, whereto pre-format information is magnetically transferred.

10. A magnetic recording medium using a master disk for magnetic transferring according to claim 4, whereto pre-format information is magnetically transferred.

11. A magnetic recording medium using a master disk for magnetic transferring according to claim 6, whereto pre-format information is magnetically transferred.
